(19) United States
(12) Patent Application Publication
(10) Pub. No.: US 2018/0080489 A1
(43) Pub. Date: Mar. 22, 2018

(54) FURNITURE ASSEMBLY BRACKET, SELF-ASSEMBLY FURNITURE USING SAME, AND ASSEMBLY METHOD THEREFOR

(71) Applicant: Jaesu KIL, Gyeonggi-do (KR)

(72) Inventor: Jaesu KIL, Gyeonggi-do (KR)

(21) Appl. No.: 15/562,163

(22) PCT Filed: Mar. 31, 2016
(86) PCT No.: PCT/KR2016/003301

§ 371 Date: Sep. 27, 2017

(30) Foreign Application Priority Data
Mar. 31, 2015 (KR) 10-2015-0044867
Aug. 24, 2015 (KR) 10-2015-0118667
Sep. 2, 2015 (KR) 10-2015-0124358

(51) Int. Cl. F16B 12/52; A47B 47/00; F16B 12/14

(52) U.S. Cl. CPC F16B 12/52; F16B 2012/446; F16B 12/14; A47B 47/00

(57) ABSTRACT

The present invention relates to a furniture assembly bracket used when an upper plate and a pillar member of furniture, assembled in the orthogonal direction, are connected, not requiring a separate fastening means since the upper plate and the pillar member are coupled in an insert-coupling manner, capable of easily separating and re-coupling the pillar member as necessary, and improving the exterior quality of the furniture. The present invention relates to the furniture assembly bracket connecting vertical support members (52), which are provided at the bottom of the upper plate (51) of the furniture, and the pillar member (55), the furniture assembly bracket comprising: an inner member (10) provided at the outer side of the pillar member (55); and an outer member (20) into which the inner member (10) is inserted and coupled and which is provided to the vertical support members (52) arranged at a predetermined angle in a state in which the vertical support members are spaced from each other such that the pillar member (55) is inserted therebetween.

### TECHNICAL FIELD

The present invention relates to a bracket used to interconnect an upper panel and a pillar member of furniture, which are assembled in directions perpendicular to each other, ready-to-assemble furniture using the brackets, and an assembly method of the furniture, and more particularly, a furniture assembly bracket capable of coupling an upper panel to a pillar member in a fitting manner without additionally using coupling means, allowing users to easily disassemble or re-assemble the pillar member as necessary, and increasing furniture exterior quality, ready-to-assemble furniture using the brackets, and an assembly method of the furniture.

### BACKGROUND ART

In general, corners of a desk, table, wardrobe, or shelf include parts where ends of three pillars, i.e., a horizontal pillar and two vertical pillars, which form a right angle therebetween.

A method of coupling the three pillars to each other includes a method using connection pins such as nails, a method of providing and combining coupling projections and recesses at coupling parts, a welding method for metallic pillars, a method using brackets, etc. Compared to other methods, a corner assembly method using brackets and coupling screws allows easy assembly and disassembly between members and thus is broadly used these days. That is, an L-shaped bracket is attached to a corner of two members contacting each other at a right angle, and then a coupling screw is fastened into the bracket, thereby coupling the bracket to the corner or a pillar member at the corner.

For example, as illustrated in FIG. 1, vertical support members 110 are provided at a corner of a bottom surface of a furniture upper panel 100 to be spaced apart from each other by a certain distance and to be perpendicular to each other, a bracket 150 is mounted between the vertical support members 110, coupling members 140 (e.g., bolts) mounted on a pillar member 120 protrude through holes of the bracket 150, and nuts are fastened to the coupling members 140 to couple the pillar member 120 and the vertical support members 110 to each other.

However, since a pillar member is coupled to vertical support members by providing a bracket therebetween, the above-described conventional furniture assembly structure does not enable easy assembly and disassembly of furniture and may not be applied to do it yourself (DIY) products which are assembled or disassembled by users.

Furthermore, in the conventional furniture assembly structure, the bracket configured as plate-shaped metal may be deformed and the pillar member may not be firmly coupled to the bracket using only the coupling means, thereby reducing stability of furniture.

Multiple technologies related to furniture assembly structures are present, and examples thereof are described below.

Patent Document 1 discloses an enhanced corner pillar assembly structure of furniture (e.g., a wardrobe, shelf, desk, or table) having corners where three pillar are coupled to each other at a right angle, and more particularly, a furniture corner pillar assembly structure capable of enabling easy and firm assembly and disassembly between a corner and a pillar using a fixing pin and an L-shaped bracket having a coupling pin on a surface thereof and having a nut hole on another surface thereof, and a pillar assembly bracket used therein.

Patent Document 2 discloses a coupling for assembling furniture by fastening a bolt into perpendicular parts of furniture, inserting a bolt body into furniture to be assembled, and coupling a fixing pin for preventing dislocation of the bolt in a direction perpendicular to the inserted bolt, thereby not exposing the coupling.

Patent Document 3 discloses an assembly structure of perpendicular plates of ready-to-assemble wooden furniture, by which a male plate may be firmly assembled to a female plate so as not be loosened or separated when rectangular plates are assembled to each other in perpendicular directions.

### PRIOR ART DOCUMENTS

### Patent Documents

(Patent Document 1) KR20-2001-0002249 U
(Patent Document 2) KR20-0331037 Y1
(Patent Document 3) KR10-1481751 B1

### DISCLOSURE

### Technical Problem

Therefore, the present invention has been made in view of the above problems, and it is one object of the present invention to provide a furniture assembly bracket capable of firmly coupling an upper panel to a pillar member of furniture in a fitting manner without additionally using coupling means, and allowing users to easily disassemble or re-assemble the pillar member from or to the upper panel as necessary, ready-to-assemble furniture using the brackets, and an assembly method of the furniture.

It is another object of the present invention to provide a furniture assembly bracket including an inner member and an outer member capable of stably and firmly coupling vertical support members of an upper panel to a pillar member in a fitting manner, ready-to-assemble furniture using the brackets, and an assembly method of the furniture.

### Technical Solution

In accordance with one aspect of the present invention, provided is a furniture assembly bracket for connecting a pair of vertical support members mounted on a bottom surface of an upper panel of furniture in directions perpendicular to each other, to a pillar member, the furniture assembly bracket including an inner member mounted outside the pillar member, and an outer member mounted between the vertical support members spaced apart from each other at a certain angle to insert the pillar member therebetween, and configured to fit the inner member thereinto.

The inner member may include a pair of fixing plates provided at a certain angle to closely contact two adjacent surfaces of the pillar member and having one or more screw holes, and a middle plate having a middle portion contacting the pillar member, and configured to interconnect the fixing plates, and the outer member may include a pair of fixing plates having one or more through holes so as to be screw-coupled to the vertical support members, a pair of connection plates connected to the fixing plates in parallel with the vertical support members, and a middle plate configured to interconnect the connection plates.

The outer member may further include a base plate having through holes so as to be screw-coupled to the upper panel, and bent from the bottom of the middle plate or the connection plates.

Cuts of a vertical direction may be provided in the fixing plates of the inner member, and coupling plates to be fitted into the cuts of the fixing plates may be provided on the connection plates of the outer member.

The outer member may further include a plurality of positioning projections protruding from ends of the fixing plates and inserted into the vertical support members.

The furniture assembly bracket may further include one or more fitting plates provided at parts where the fixing plates and the connection plates of the outer member are connected to each other, so as to insert the fixing plates of the inner member thereinto, and the fitting plates may include extending parts extending from the fixing plates, and fitting parts bent from ends of the extending parts to insert the fixing plates of the inner member thereinto.

Side ridges other than top ridges of the fixing plates of the inner member may have a small thickness so as to be inserted into the fitting plates, and the fixing plates may have a descending width in a downward direction.

The inner and outer members may be produced using a forging process, the inner member may include a pair of fixing parts provided at a certain angle to closely contact two adjacent surfaces of the pillar member and having one or more screw holes in outer hollow parts thereof, a middle part having a middle portion contacting a corner of the pillar member, configured to interconnect the fixing parts, and having at least one through hole, and a ridge provided on top surfaces of the fixing parts and the middle part and having a head-hiding screw hole in a corner thereof, and the outer member may include a pair of fixing parts having one or more through holes so as to be screw-coupled to the vertical support members, connection parts connected to the fixing parts in parallel with the vertical support members, a middle part having a screw hole corresponding to the head-hiding screw hole in a top surface thereof, having a through hole corresponding to the through hole of the inner member and configured as a slot hole, and configured to interconnect the connection parts, a base plate having through holes configured as slot holes so as to be screw-coupled to the upper panel, and connected to the bottom of the middle part or the connection parts, and fitting parts extending from the fixing parts and then bent so as to insert the fixing parts of the inner member thereinto.

The inner and outer members may be produced using a forging process, the inner member may include a pair of fixing parts closely contacting inner surfaces of an L-shaped pillar member and having one or more screw holes, a middle surface part having a flat surface shape, located to face a corner of the fixing parts, and having a through hole at the center thereof, connection parts configured to interconnect the fixing parts and the middle surface part and having rectangular through holes, and a cover part provided on the top of the fixing parts, the connection parts, and the middle surface part and having a head-hiding screw hole provided in a corner thereof, which protrudes from the middle surface part, and the outer member may include a pair of fixing parts having one or more through holes so as to be screw-coupled to the vertical support members, connection parts connected to the fixing parts in parallel with the vertical support members, a middle part having a screw hole corresponding to the head-hiding screw hole in a top surface thereof, having a through hole corresponding to the through hole of the inner member and configured as a slot hole, and configured to interconnect the connection parts, a base plate having through holes configured as slot holes so as to be screw-coupled to the upper panel, and connected to the bottom of the middle part or the connection parts, and fitting parts extending from the fixing parts and then bent so as to insert the fixing parts of the inner member thereinto.

The inner member may be produced separately as a first member coupled to the outer member, and a second member mounted on the pillar member and coupled to inside of the first member.

The first member may include a pair connection surfaces including hollow parts having one or more screw holes, and provided at an angle of 90°, a first middle surface having a hollow part in a rear surface thereof, having a head-hiding screw hole at the center thereof, and configured to interconnect the connection surfaces, and a ridge protruding forward from the bottom of the connection surfaces and the first middle surface and having a head-hiding screw hole corresponding to a screw hole provided at the center of the outer member, in a corner thereof, and the second member may include a pair of fixing parts having a flat surface shape, having one or more screw holes, and connected to each other at an angle of 90°, connection parts having a flat surface shape, connected to ends of the fixing parts at an angle of 90°, having rectangular through holes, and closely contacting the connection surfaces of the first member, and a second middle surface located to face a corner of the fixing parts, having a through hole corresponding to the head-hiding screw hole of the first member, and inserted into the hollow part provided in the rear surface of the first middle surface.

The outer member may include a pair of fixing parts having one or more through holes so as to be screw-coupled to the horizontal support members, connection parts connected to the fixing parts in parallel with the horizontal support members, a middle part having a screw hole corresponding to the head-hiding screw hole of the ridge, in a top surface thereof, having a head-hiding screw hole corresponding to the head-hiding screw hole of the first middle surface, and configured to interconnect the connection parts, and a base plate having through holes configured as slot holes so as to be screw-coupled to the upper panel, and connected to the top of the middle part or the connection parts.

In accordance with another aspect of the present invention, provided is ready-to-assemble furniture including two or more pillar members, a plurality of inner members separately mounted on the pillar members, and a plurality of outer members configured to fit the inner brackets thereinto.

In accordance with another aspect of the present invention, provided is ready-to-assemble furniture including a pair of front pillar members spaced apart from each other by a certain distance, rear pillar members spaced apart from the front pillar members by a certain distance and spaced apart from each other by the same distance as the front pillar members, side panels provided and fixed between the front and rear pillar members, a rear panel provided and fixed between the rear pillar members, a plurality of upper panels inserted and fixed into an internal space provided by the front and rear pillar members, a plurality of inner brackets separately mounted on the front and rear pillar members, and a plurality of outer brackets mounted on bottom surfaces of the upper panels, mounted on the horizontal support members spaced apart from each other at a certain angle to insert the pillar members therebetween, and configured to fit the inner brackets thereinto.

In accordance with yet another aspect of the present invention, provided is an assembly method of ready-to-assemble furniture, the assembly method including separately mounting inner brackets on two or more pillar members, mounting horizontal support members on bottom surfaces of upper panels and mounting outer brackets between the horizontal support members, providing a pair of rear pillar members to be spaced apart from each other by a certain distance and to locate the inner brackets at inner sides thereof and providing front pillar members to be spaced apart from the rear pillar members by a certain distance and to locate the inner brackets at inner sides thereof, and inserting the upper panels into an internal space provided by the pillar members and then coupling the outer brackets of the upper panels to the inner brackets of the pillar members to fix the upper panels, slidably coupling the rear panel between the rear pillar members, and slidably coupling the side panels between the rear and front pillar members.

### Advantageous Effects

Based on a furniture assembly bracket according to the present invention, since an inner member mounted on a pillar member is fitted into an outer member mounted on vertical support members of an upper panel to couple the pillar member to the vertical support members, a user may easily disassemble or re-assemble the pillar member, the furniture assembly bracket may be applied to do it yourself (DIY) products, user convenience may be ensured because the pillar member is coupled to the upper panel without additionally using coupling means, and furniture exterior quality may be increased.

Furthermore, since the inner member firmly coupled to the pillar member is fitted into the outer member firmly coupled to the vertical support members of the upper panel, coupling force between the vertical support members of the upper panel and the pillar member may be high and the pillar member may not be loosened.

Additionally, the structure of the inner member may be changed to be applicable to an L-shaped pillar member as well as a typical rectangular pillar member.

In addition, the furniture assembly bracket may be applied to various types of furniture, e.g., dining tables and shelves.

Based on ready-to-assemble furniture and an assembly method thereof according to the present invention, since the furniture is sold after an inner member is coupled to a pillar member and an outer member is coupled to a vertical plate in such a manner that a user may directly assemble the furniture, sales and transportation may be easy and user satisfaction may be increased.

### DESCRIPTION OF DRAWINGS

FIG. 1 is a reference view of a conventional furniture assembly bracket.

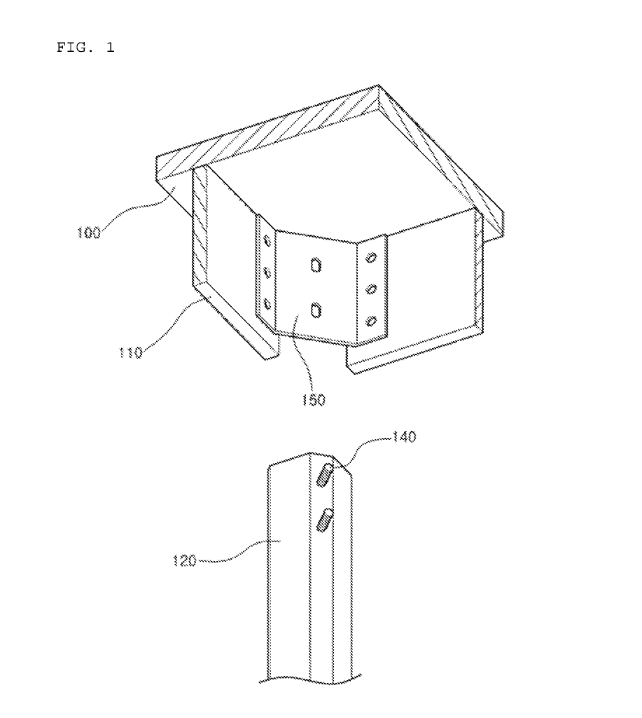

FIG. 2 is a structural view of a furniture assembly bracket according to the present invention.

FIG. 3 is an exploded perspective view of the furniture assembly bracket according to the present invention.

FIG. 4 is a rear exploded perspective view of the furniture assembly bracket according to the present invention.

FIG. 5 is a perspective view of a furniture assembly bracket according to a second embodiment of the present invention.

FIG. 6 is a perspective view of a furniture assembly bracket according to a third embodiment of the present invention.

FIG. 7 is a perspective view of a furniture assembly bracket according to a fourth embodiment of the present invention.

FIG. 8 is a perspective view of a furniture assembly bracket according to a fifth embodiment of the present invention.

FIG. 9 is a perspective view of a furniture assembly bracket according to a sixth embodiment of the present invention.

FIG. 10 is a perspective view of a furniture assembly bracket according to a seventh embodiment of the present invention.

FIG. 11 is a rear perspective view of the furniture assembly bracket according to the seventh embodiment of the present invention.

FIG. 12 is a reference view showing furniture assembly using the seventh embodiment.

FIG. 13 is an exploded perspective view of an inner bracket and an outer bracket according to an eighth embodiment.

FIG. 14 is a reference view showing various coupling forms between the inner bracket and a pillar member according to the eighth embodiment.

FIG. 15 is an exploded perspective view of an inner bracket and an outer bracket according to a ninth embodiment.

FIG. 16 is a rear exploded perspective view of the inner bracket and the outer bracket according to the ninth embodiment.

FIG. 17 is an exploded perspective view of an inner bracket and an outer bracket according to a tenth embodiment.

FIG. 18 is a rear perspective view of a second member according to the tenth embodiment.

FIG. 19 is a structural view of ready-to-assemble furniture according to the present invention.

FIG. 20 is a perspective view of a coupling part between an inner bracket and an outer bracket, according to the present invention.

FIG. 21 is a flowchart of an assembly method of ready-to-assemble furniture, according to the present invention.

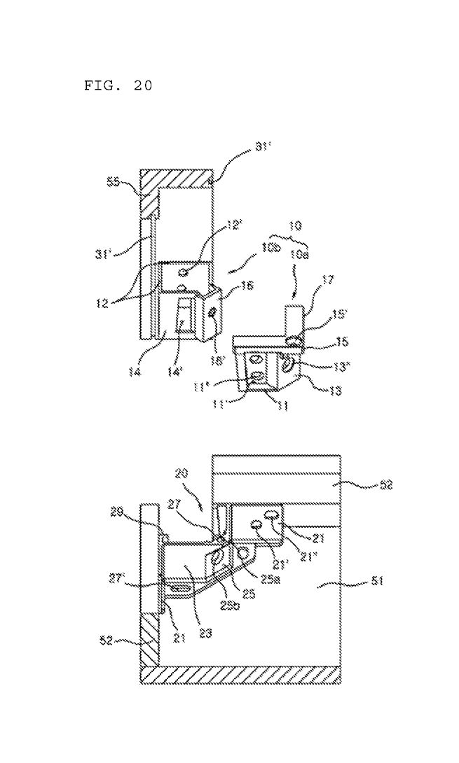

FIG. 20 is a perspective view of a coupling part between an inner bracket and an outer bracket, according to the present invention.

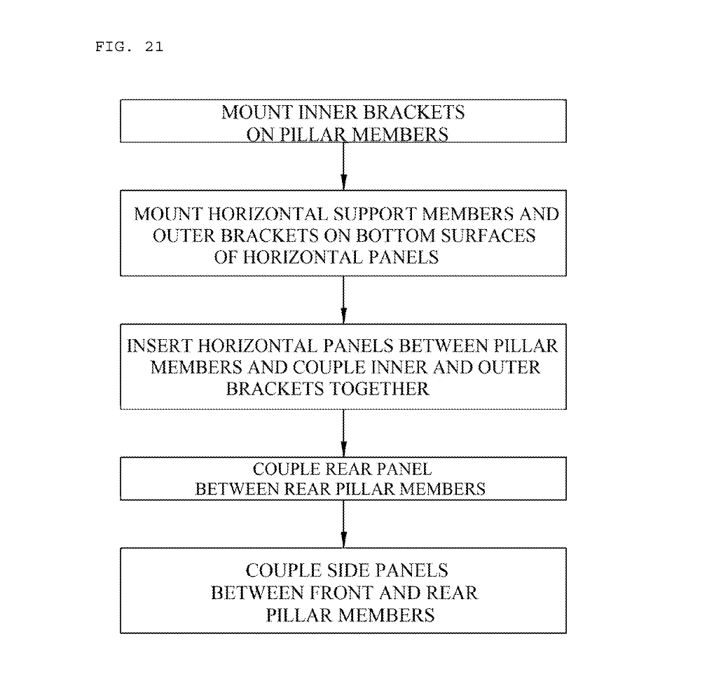

FIG. 21 is a flowchart of an assembly method of ready-to-assemble furniture, according to the present invention.

### BEST MODE

Hereinafter, the present invention will be described in detail by explaining embodiments of the invention with reference to the attached drawings.

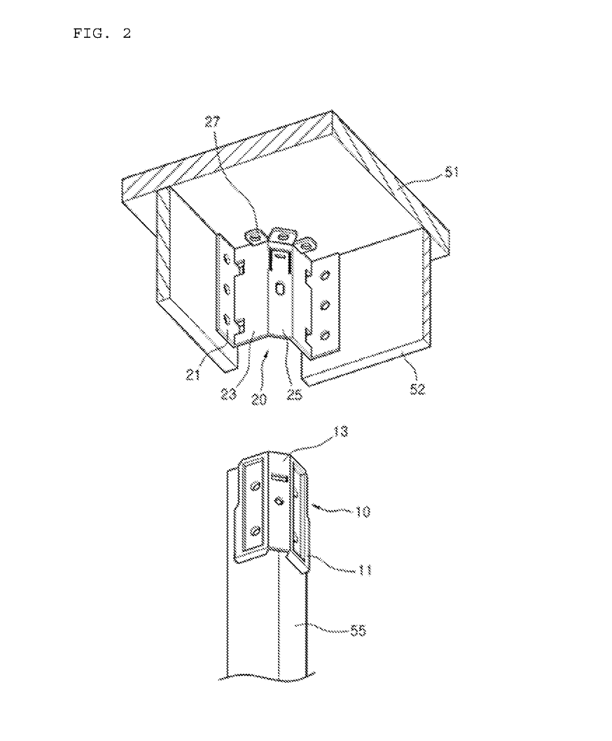

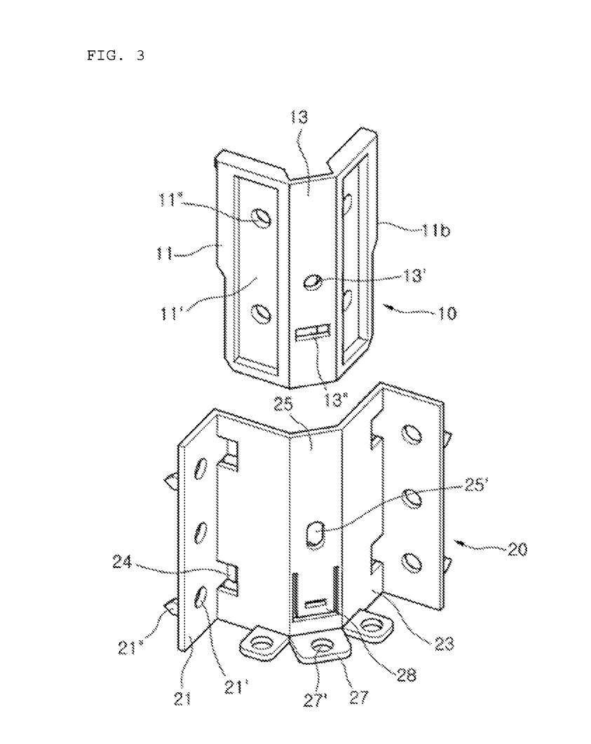

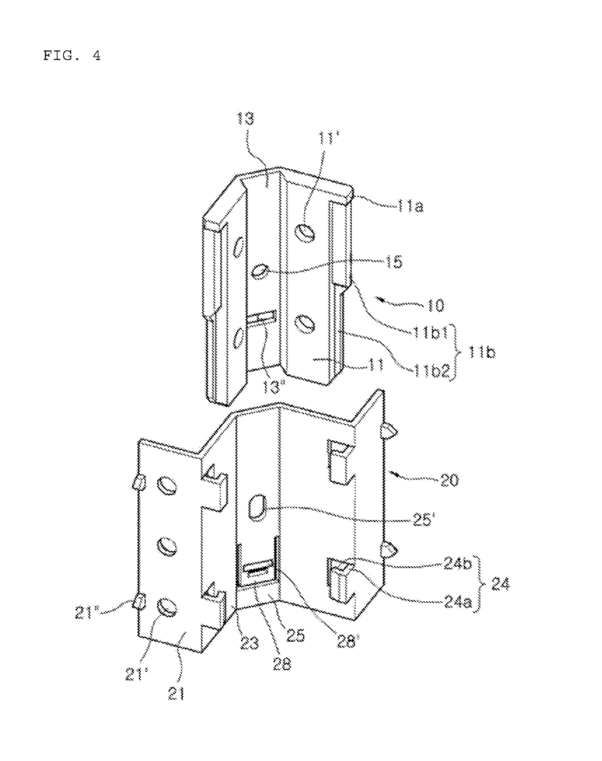

As illustrated in FIGS. 2 to 4, a furniture assembly bracket for connecting a pair of vertical support members 52 mounted on a bottom surface of an upper panel 51 of furniture in directions perpendicular to each other, to a pillar member 55, according to the present invention, includes an inner member 10 mounted outside the pillar member 55, and an outer member 20 mounted on the vertical support members 52 spaced apart from each other at a certain angle to insert the pillar member 55 therebetween, and configured to fit the inner member 10 thereinto.

The inner member 10 includes a pair of fixing plates provided at a certain angle to closely contact two adjacent surfaces of the pillar member 55 and having one or more screw holes 11″ in outer hollow parts 11′ thereof, and a middle plate 13 having a middle portion contacting a corner of the pillar member 55, having a smaller thickness than the fixing plates 11, and configured to interconnect the fixing plates 11.

The outer hollow parts 11′ are provided in the fixing plates 11 to prevent protrusion of heads of screws for coupling the fixing plates 11 to the pillar member 55, from the fixing plates 11. As such, when the inner member coupled to the pillar member 55 is fitted into the outer member 20 coupled to the upper panel 51, interference with the outer member 20 due to the screws protruding from the fixing plates 11 does not occur.

The outer member 20 includes a pair of fixing plates 21 having one or more through holes 21′ so as to be screw-coupled to the vertical support members 52, a pair of connection plates 23 connected to the fixing plates 21 in parallel with the vertical support members 52, a middle plate 25 configured to interconnect the connection plates 23, and a base plate 27 having through holes 27′ so as to be screw-coupled to the upper panel 51, and bent from the bottom of the middle plate 25 or the connection plates 23. Accordingly, the base plate 27 may be provided at the middle plate 25, the connection plates 23, or both.

Preferably, at least one hole 25′ or 13′ configured to insert a joint pin (not shown) or a coupling screw thereinto is provided in the middle plate 25 of the outer member 20 and the middle plate 13 of the inner member 10 in order to couple the inner and outer members 10 and 20 to each other or to integrally couple the inner and outer members 10 and 20 and the pillar member 55 to each other. Preferably, the hole 25′ provided in the middle plate 25 of the outer member 20 is configured as a slot hole.

An elastic coupling part 28 may be generated by providing a coupling projection 28′ on an upper or lower part of a rear surface of the middle plate 25 of the outer member 20 and cutting three sides around the coupling projection 28′, and a coupling hole 13″ configured to insert the coupling projection 28′ thereinto may be provided in a horizontal direction in the middle plate 13 of the inner member 10.

As such, when the inner member 10 is coupled to the outer member 20, since the coupling projection 28′ provided on the rear surface of the elastic coupling part is elastically coupled to the coupling hole 13″ provided in the middle plate 13 of the inner member 10, the inner member 10 may be fixed in place and a joint pin may be accurately coupled.

The outer member 20 may further include a plurality of positioning projections 21″ protruding from ends of the fixing plates 21 and inserted into the vertical support members 52 in order to mount the outer member 20 on the support member 52 at an accurate location.

In this case, preferably, the positioning projections 21″ have sharp ends in order to easily determine the locations of holes, into which the positioning projections 21″ are to be inserted, when the fixing plates 21 are attached to the vertical support members 52. In other words, hole locations may be marked by pressing the positioning projections 21″ on the vertical support members 52 and holes may be created using a boring tool such as a drill.

Preferably, fitting plates 24 are provided at parts where the fixing plates 21 and the connection plates 23 of the outer member 20 are connected to each other, so as to insert the fixing plates 11 of the inner member 10 thereinto, and side ridges 11b other than top ridges 11a of the fixing plates 11 of the inner member 10 have a small thickness so as to be inserted into the fitting plates 24. In this case, preferably, the fixing plates 11 have a descending width in a downward direction in order to easily insert the side ridges 11b into the fitting plates 24.

The fitting plates 24 may be generated integrally with the connection plates 23 using a molding process or the like. When the connection plates 23 are generated using a plate material, parts of the connection plates 23 may be cut to generate the fitting plates 24. In this case, the fitting plates 24 include extending parts 24a extending from the fixing plates 21, and fitting parts 24b bent from ends of the extending parts 24a to insert the fixing plates 11 of the inner member 10 thereinto. The side ridges 11b may be divided into upper side ridges 11b1 and lower side ridges 11b2. In this case, preferably, the lower side ridges 11b2 have a smaller thickness than the upper side ridges 11b1.

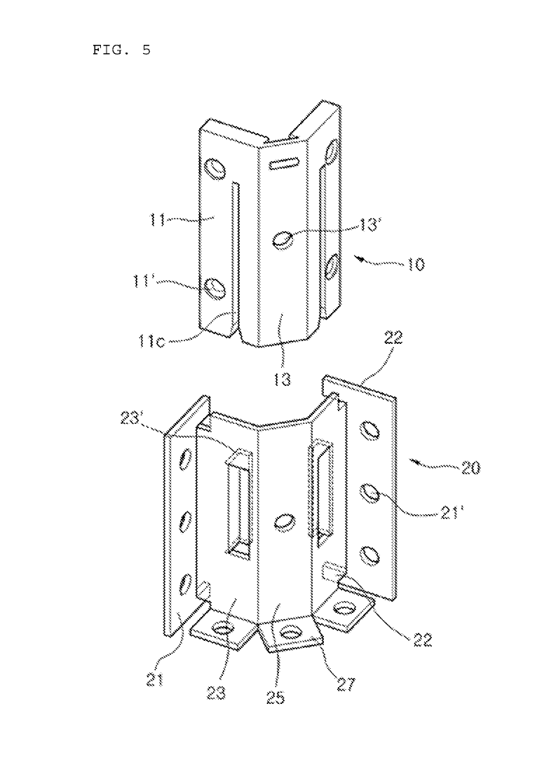

The above-described furniture assembly bracket according to the present invention may be variously modified, and various modified embodiments are illustrated in FIG. 5, etc.

For example, as illustrated in FIG. 5, cuts 11c of a vertical direction may be provided in the fixing plates 11 of the inner member 10, and coupling plates 23′ to be fitted into the cuts 11c of the fixing plates 11 may be provided on the connection plates 23 of the outer member 20.

The outer member 20 may further include a plurality of stopping plates 22 extending from top and bottom ends of the fixing plates 21 connected to the connection plates 23, to prevent dislocation of the inner member 10.

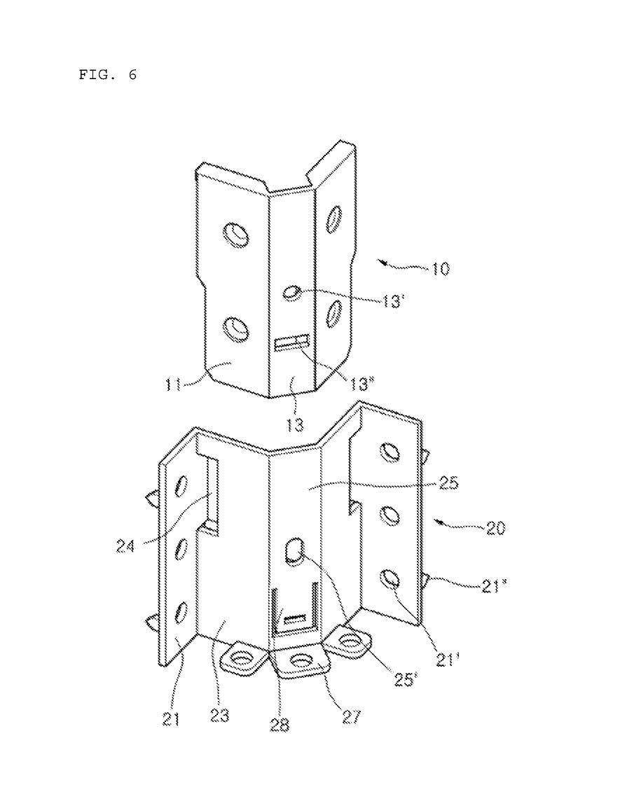

FIG. 6 illustrates a furniture assembly bracket including the inner member 10 in which the hole 13′ is provided in a center part of the middle plate 13 to insert a joint pin thereinto, and the coupling hole 13″ is provided below the hole 13′, and the outer member 20 in which the hole 25′ configured as a slot hole is provided in a center part of the middle plate 25, the elastic coupling part 28 is provided at a location corresponding to the coupling hole 13″ of the inner member 10, the fitting plates 24 are provided at sides of the connection plates 23, and the positioning projections 28 are provided on the fixing plates 21.

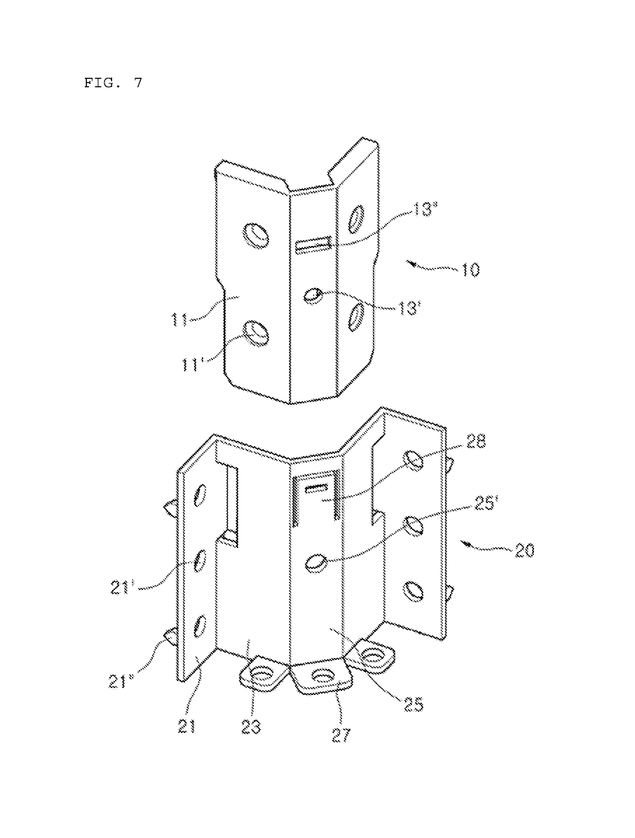

In this case, as illustrated in FIG. 7, the coupling hole 13″ provided in the middle plate 13 of the inner member 10 and the elastic coupling part 28 provided on the middle plate 25 of the outer member 20 may be provided above the holes 13′ and 25′. That is, the location of an elastic coupling structure including the coupling hole 13″ and the coupling projection 28′ provided on the rear surface of the elastic coupling part 28 is not limited to any particular location.

Although the inner and outer members 10 and 20 according to the above-described embodiments are produced using plate materials, in the following description, an inner member 60 and an outer member 70 may be produced using a forging process.

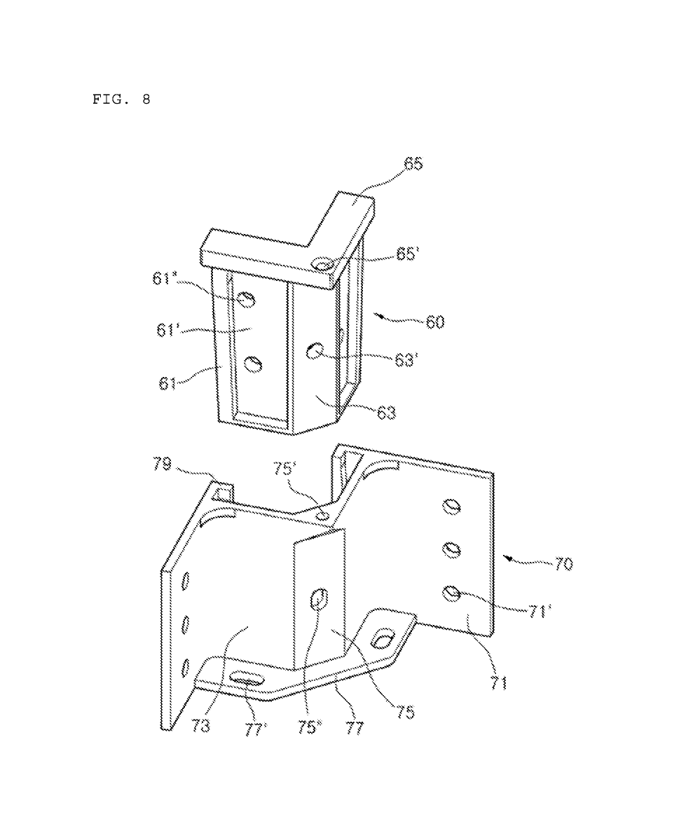

As illustrated in FIG. 8, the inner member 60 includes a pair of fixing parts 61 provided at a certain angle to closely contact two adjacent surfaces of the pillar member 55 and having one or more screw holes 61″ in outer hollow parts 61′ thereof, a middle part 63 having a middle portion contacting a corner of the pillar member 55, configured to interconnect the fixing parts 61, and having at least one through hole 63′, and a ridge 65 provided on top surfaces of the fixing parts 61 and the middle part 63 and having a head-hiding screw hole 65′ in a corner thereof.

The outer member 70 includes a pair of fixing parts 71 having one or more through holes 71′ so as to be screw-coupled to the vertical support members 52, connection parts 73 connected to the fixing parts 71 in parallel with the vertical support members 52, a middle part 75 having a screw hole 75′ corresponding to the head-hiding screw hole 65′ in a top surface thereof, having a through hole 75″ corresponding to the through hole 63′ and configured as a slot hole, and configured to interconnect the connection parts 73, a base plate 77 having through holes 77′ configured as slot holes so as to be screw-coupled to the upper panel 51, and connected to the bottom of the middle part 75 or the connection parts 73, and fitting parts 79 extending from the fixing parts 71 and then bent so as to insert the fixing parts 61 of the inner member 60 thereinto.

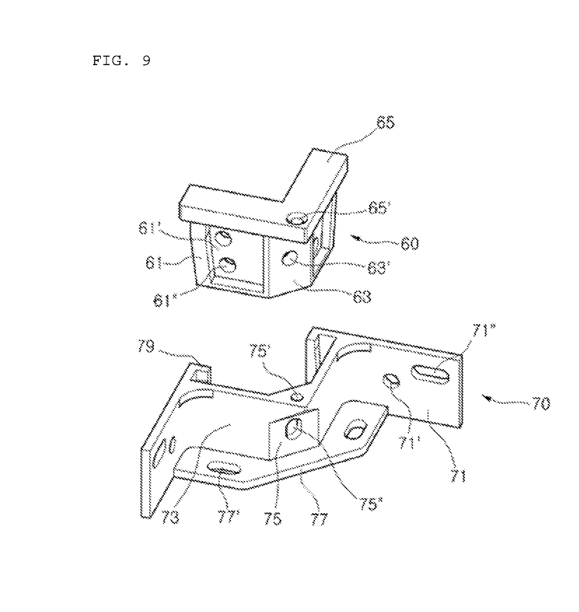

In this case, as illustrated in FIG. 9, the inner and outer members 60 and 70 may have small heights, the fixing parts 71 of the outer member 70 may have a length greater than a height thereof, and at least some of the through holes 71′ provided in the fixing parts 71 may be configured as slot holes 71″ extending in a length direction of the fixing parts 71.

As such, the pillar member 55 and the upper panel 51 may be coupled to each other using the inner and outer members 60 and 70 produced using a forging process instead of bending plate materials. In addition, the pillar member 55 and the upper panel 51 may be firmly coupled to each other using high-strength characteristics of forged products.

Although a bracket capable of coupling the rectangular pillar member 55 to the vertical support members 52 has been described above, if a forged bracket is used, instead of the rectangular pillar member 55, an L-shaped pillar member 55′ may be coupled to the vertical support members 52.

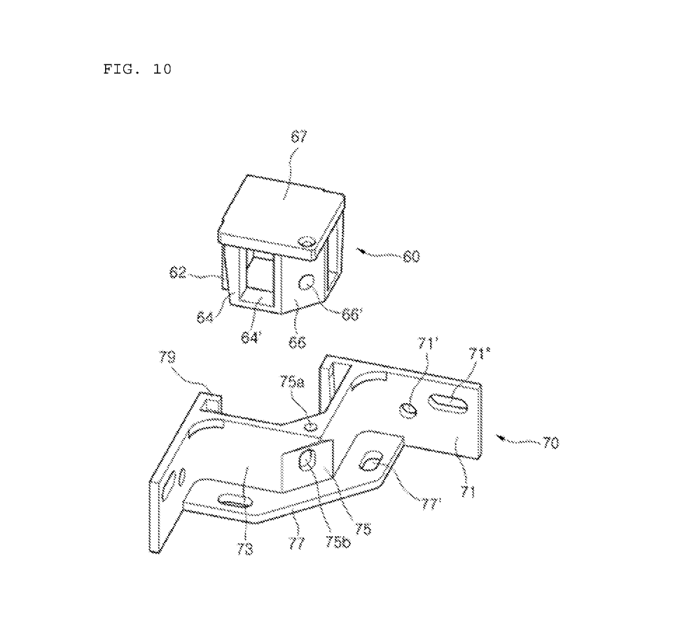

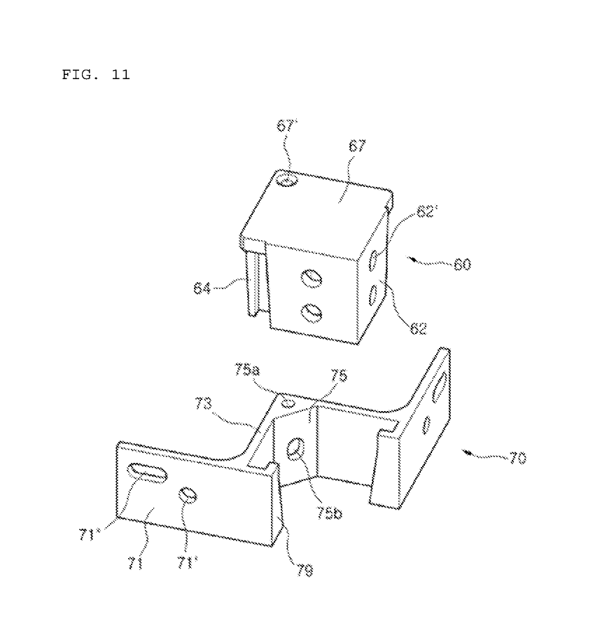

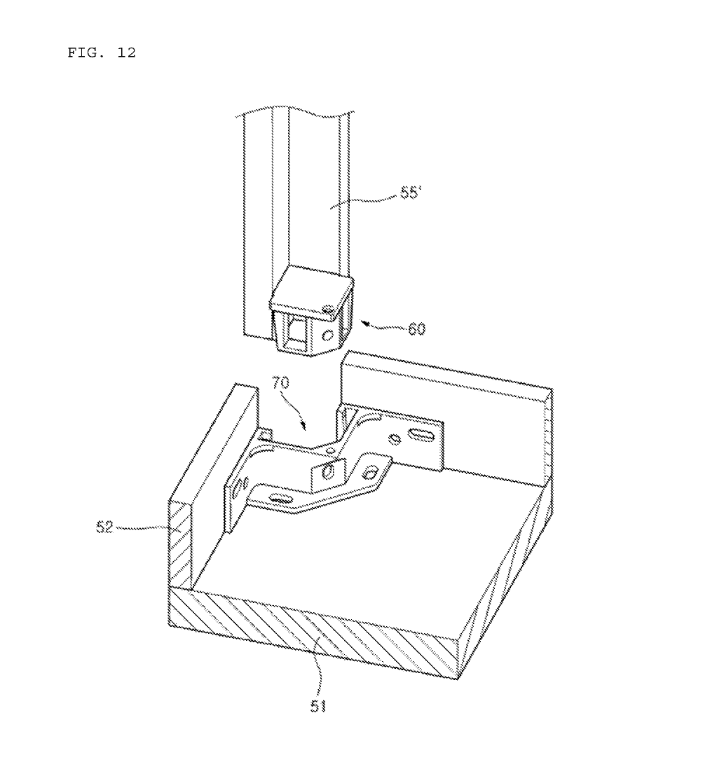

In this case, as illustrated in FIGS. 10 to 12, the inner member 60 includes a pair of fixing parts 62 closely contacting inner surfaces of the L-shaped pillar member 55′ and having one or more screw holes 62′, a middle surface part 66 having a flat surface shape, located to face a corner of the fixing parts 62, and having a through hole 66′ at the center thereof, connection parts 64 configured to interconnect the fixing parts 62 and the middle surface part 66 and having rectangular through holes 64′, and a cover part 67 provided on the top of the fixing parts 62, the connection parts 64, and the middle surface part 66 and having a head-hiding screw hole 67′ provided in a corner thereof, which protrudes from the middle surface part 66.

The outer member 70 includes a pair of fixing parts 71 having one or more through holes 71′ so as to be screw-coupled to the vertical support members 52, connection parts 73 connected to the fixing parts 71 in parallel with the vertical support members 52, a middle part 75 having a screw hole 75a corresponding to the head-hiding screw hole 67′ in a top surface thereof, having a through hole 75b corresponding to the through hole 66′ and configured as a slot hole, and configured to interconnect the connection parts 73, a base plate 77 having through holes 77′ configured as slot holes so as to be screw-coupled to the upper panel 51, and connected to the bottom of the middle part 75 or the connection parts 73, and fitting parts 79 extending from the fixing parts 71 and then bent so as to insert the fixing parts 61 of the inner member 60 thereinto.

In this case, preferably, the fixing parts 71 of the outer member 70 have a length greater than a height thereof, and at least some of the through holes 71′ provided in the fixing parts 71 are configured as slot holes 71″ extending in a length direction of the fixing parts 71.

As such, the present invention may also be applied to the L-shaped pillar member 55′ having a large contact area compared to the typical rectangular pillar member 55.

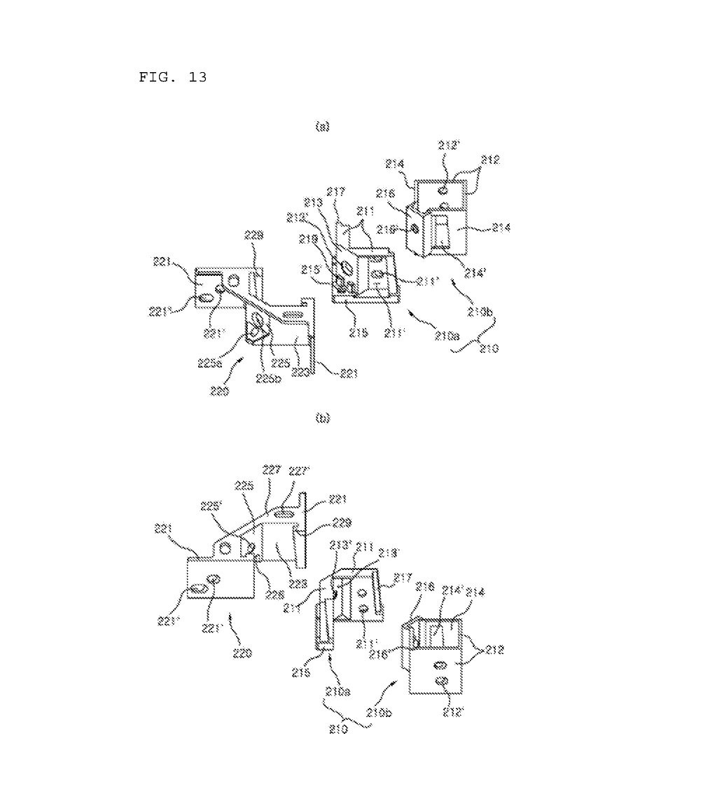

Since the inner member 210 of FIGS. 10 to 12 may not be easily molded using a forging process, as illustrated in FIG. 13, an inner member 210 may be molded as separate parts and then the molded parts may be assembled.

Herein, preferably, the inner member 210 is produced separately as a first member 210a coupled to an outer member 220, and a second member 210b mounted on the pillar member and coupled to the inside of the first member 210a.

In detail, the first member 210a includes a pair connection surfaces 211 including hollow parts 211′ having one or more screw holes 211″, and provided at an angle of 90°, a first middle surface 213 having a hollow part 213′ in a rear surface thereof, having a head-hiding screw hole 213″ at the center thereof, and configured to interconnect the connection surfaces 211, a ridge 215 protruding forward from the bottom of the connection surfaces 211 and the first middle surface 213 and having a head-hiding screw hole 215′ corresponding to a screw hole 225a provided at the center of the outer member 220, in a corner thereof, and protruding parts 217 provided in a vertical direction and protruding from outer edges of the connection surfaces 211.

The second member 210b includes a pair of fixing parts 212 having a flat surface shape, having one or more screw holes 212′, and connected to each other at an angle of 90°, connection parts 214 having a flat surface shape, connected to ends of the fixing parts 212 at an angle of 90°, having rectangular through holes 214′, and closely contacting the connection surfaces 211 of the first member 210a, and a second middle surface 216 located to face a corner of the fixing parts 212, having a through hole 216′ corresponding to the head-hiding screw hole 213″ of the first member 210a, and inserted into the hollow part 213′ provided in the rear surface of the first middle surface 213.

The outer member 220 includes a pair of fixing parts 221 having one or more through holes 221′ and slot holes 221″ so as to be screw-coupled to the vertical support members 52, connection parts 223 connected to the fixing parts 221 in parallel with the vertical support members 52, a middle part 225 having a screw hole 225a corresponding to the head-hiding screw hole 215′ of the ridge 215, in a top surface thereof, having a head-hiding screw hole 225b corresponding to the head-hiding screw hole 213″ of the first middle surface 213, and configured to interconnect the connection parts 223, a base plate 227 having through holes 227′ configured as slot holes so as to be screw-coupled to the upper panel 51, and connected to the top of the middle part 225 or the connection parts 223, and fitting parts 229 extending from the fixing parts 221 and configured to insert the protruding parts 217 of the inner member thereinto.

In this case, preferably, one or more positioning projections 219 are provided on an outer surface of the first middle surface 213 of the inner member 210, and positioning recesses 226 configured to insert the positioning projections 219 thereinto are provided in an inner surface of the middle part 225 of the outer member 220. The positioning projections 219 and the positioning recesses 226 allow the inner and outer members 210 and 220 to be coupled to each other at an accurate location. In some cases, positioning projections may be provided on the inner surface of the middle part 225 of the outer member 220, and positioning recesses may be provided in the outer surface of the first middle surface 213 of the inner member 210.

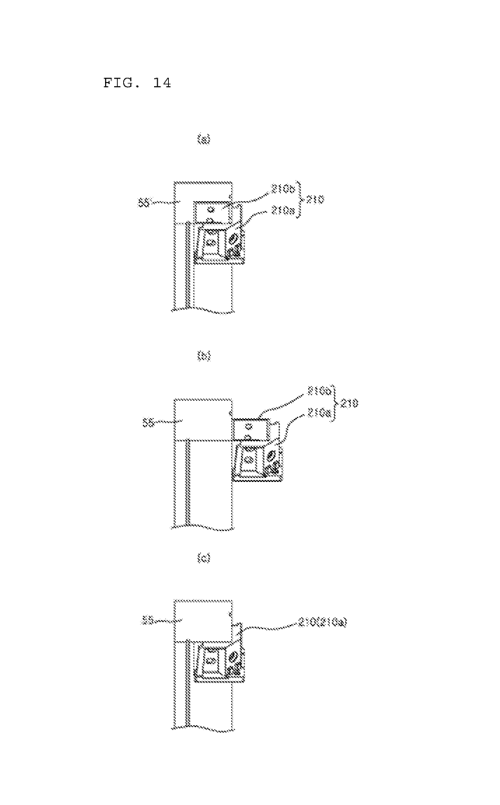

As illustrated in FIG. 14, the inner member 210 may be inserted and mounted in an inner corner of the L-shaped pillar member 55′, or on a surface or a corner of the linear pillar member 55.

When the inner member 210 is mounted in an inner corner of the L-shaped pillar member 55′ or on a surface of the linear pillar member 55, as illustrated in (a) and (b) of FIG. 14, the second member 210b is located in such a manner that the fixing parts 212 of the second member 210b closely contact two surfaces of the inner corner of the L-shaped pillar member 55′ or the surface of the linear pillar member 55, and then screws are fastened simultaneously through the screw holes 211′ provided in the connection surfaces 211 of the first member 210a and the screw holes 212′ provided in the fixing parts 212 of the second member 210b while the second middle surface 216 of the second member 210b is being inserted into the hollow part 213′ provided in the rear surface of the first middle surface 213 of the first member 210a, thereby fixing the inner member 210 including the first and second members 210a and 210b.

When the inner member 210 is mounted on a corner of the linear pillar member 55, as illustrated in (c) of FIG. 14, the first member 210a is provided in such a manner that the connection surfaces 211 of the first member 210a closely contact two side surfaces of the corner of the linear pillar member 55, and then screws are fastened through the screw holes 211′ provided in the connection surfaces 211 of the first member 210a, thereby fixing the inner member 210. In this case, the second member 210b is not used.

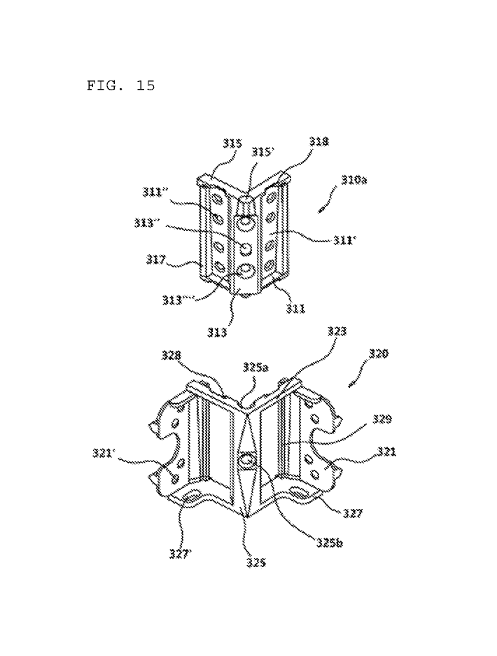

A bracket illustrated in FIG. 15 according to another embodiment includes an outer member 320 and an inner member 310, and the inner member 310 includes a first member 310a and a second member 320b. In this case, the first member 310a may be solely used as the inner member as illustrated in (c) of FIG. 14, and thus a case in which only the first member is used will be described first.

The first member 310a of the inner member 310 includes a pair of connection surfaces 311, a first middle surface 313, and a ridge 315.

The connection surfaces 311 are provided at an angle of 90°.

Since a hollow part 311′ having one or more screw holes 311″ is provided in each connection surface 311, unnecessary waste of raw material may be prevented and a light weight may be achieved.

A protruding part 317 of a vertical direction is provided on an outer edge of each connection surface 311.

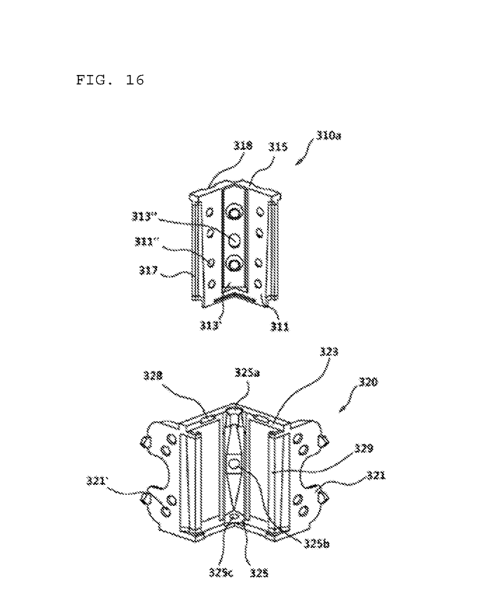

Referring to FIG. 16, each protruding part 317 may be inclined inward and downward while top and bottom ends thereof may be provided in a vertical direction, the whole protruding part 317 from the top end to the bottom end may be provided in a vertical direction, or the whole protruding part 317 from the top end to the bottom end may be inclined inward and downward.

The protruding parts 317 serves to couple the first member 310a of the inner member 310 to the outer member 320, and a description thereof will be provided below together with the description of the outer member 320.

The first middle surface 313 serves to interconnect the connection surfaces 311.

A hollow part 313′ is provided in a rear surface of the first middle surface 313, and one or more screw holes 313″ are provided in a middle portion of the first middle surface 313.

In detail, referring to FIG. 15, the screw hole 313″ provided at the center of the first middle surface 313 is provided to be screw-coupled to the outer member 320, and head-hiding holes 313″ may be further provided in the other screw holes 313″ provided above and below the screw hole 313″ provided at the center of the first middle surface 313.

The hollow part 313′ provided in the rear surface of the first middle surface 313 has the same effect as the hollow parts 311′ provided in the connection surfaces 311.

The ridge 315 protrudes forward from the top of the connection surfaces 311 and the first middle surface 313.

A partial screw hole 315′ is provided in a center corner so as to be screw-coupled to the outer member 320.

Since the partial screw hole 315′ has a form of a vertically cut female screw as illustrated in FIG. 15, a screw may be fastened by merely coupling the outer member 320 to the first member 310a of the inner member 310 and thus coupling force between the outer member 320 and the first member 310a of the inner member 310 may be increased.

One or more separation recesses 318, which are open downward, may be provided in the ridge 315 protruding forward from the top of the connection surfaces 311.

The first member 310a of the inner member 310 may be easily separated from the outer member 320 by slightly fitting a flat-headed tool such as a flat-blade screwdriver into the separation recesses 318.

The outer member 320 includes a pair of fixing parts 321, connection parts 323, a middle part 325, and a base plate 327.

The fixing parts 321 is provided to correspond to an angle of the vertical support members 52 so as to be fixed to the vertical support members 52 in contact with the vertical support members 52.

In detail, one or more through holes 321′ are provided in the fixing parts 321 so as to be screw-coupled and fixed to the vertical support members 52.

The connection parts 323 are configured as frames connected to the fixing parts 321 in parallel with the vertical support members 52.

Since the connection parts 323 are configured as frames, unnecessary waste of raw material may be prevented, a light weight may be achieved, and screws may be easily fastened into the hollow parts 311′.

Separation parts 328 may be provided in the connection parts 323 at locations corresponding to the separation recesses 318 of the ridge 315.

The function of the separation parts 328 is the same as that of the separation recesses 318, and thus a detailed description thereof is not provided herein.

The middle part 325 is provided to interconnect the connection parts 323.

A cut screw hole 325a corresponding to the partial screw hole 315′ of the ridge 315 is provided in a top surface of the middle part 325, and a center screw hole 325b corresponding to the screw hole 313″ of the first middle surface 313 is provided.

A bottom screw hole 325c may be further provided in the bottom of the middle part 325 so as to be screw-coupled to the upper panel 51.

The cut screw hole 325a corresponds to the partial screw hole 315′ of the ridge 315. When the inner member 310 is inserted into the outer member 320, the cut screw hole 325a and the partial screw hole 315′ configure a whole female screw and thus a screw may be inserted and fixed thereinto.

Since the center screw hole 325b is provided at a location corresponding to the screw hole 313″ provided in the first middle surface 313, the outer member 320 may be more firmly coupled to the inner member 310 by inserting a screw into the center screw hole 325b.

In addition, the bottom screw hole 325c is provided in the bottom of the middle part 325 so as to be screw-coupled to the upper panel 51.

The base plate 327 is provided to be screw-coupled to the upper panel 51.

The base plate 327 is connected to the top of the fixing parts 321 or the connection parts 323, and has the through holes 327′ configured as slot holes so as to be firmly screw-coupled to the bottom surface of the upper panel 51.

The outer member 320 may include fitting parts 329 extending from the fixing parts 321 to insert the protruding parts 317 of the inner member 310 thereinto.

The fitting parts 329 are provided in a shape corresponding to the protruding parts 317 and are coupled to the protruding parts 317.

The fitting parts 329 extend in an L shape from the fixing parts 321, and thus may not be easily produced using a conventional mold.

For example, when the outer member 320 having a W shape is produced using a mold having a W-shaped concavo-convex pattern, the fitting parts 329 extending from the fixing parts 321 and then bent to face each other should be additionally generated using a slide mold corresponding to the shape of the fitting parts 329. As such, compared to production of a general bracket, mold size is increased and more time and more processes are required.

However, when the fitting parts 329 are produced, since the connection parts 323 are configured as frames as described above, a small mold may be used.

Since the fitting parts 329 are produced as described above, time, mold size, and waste of raw material may be reduced and thus the outer member 320 may be easily produced.

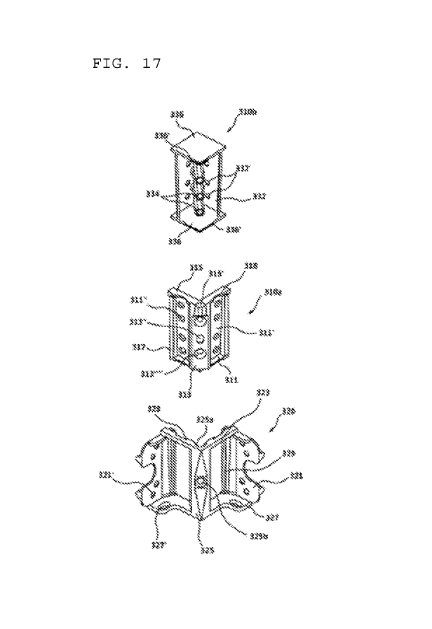

A bracket using the additionally mountable second member 320b, according to another embodiment, will now be described with reference to FIG. 17. Herein, the first member 310a of the inner member 310 and the outer member 320 are the same as those of the previous embodiment, and thus a description thereof is not additionally provided herein.

The second member 320b coupled to the inner member 310 inserted into the outer member 320 coupled to the vertical support members 52 is fixed to the pillar 41 and includes a pair of fixing parts 332, one or more long screw holes 334, and one or more fixing plates 336.

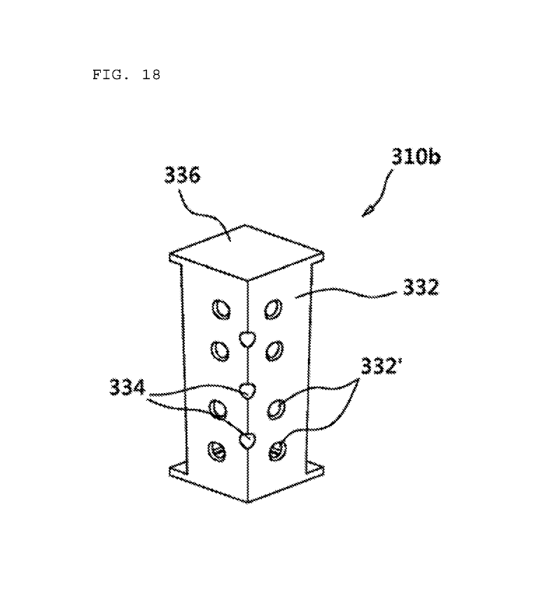

As illustrated in FIGS. 17 and 18, the fixing parts 332 have a flat surface shape and are connected to each other at an angle of 90°.

Each fixing part 332 has one or more screw holes 332′.

The second member is coupled to the pillar member 55 by inserting screws into the screw holes 332′.

The long screw holes 334 are provided in a center corner of the fixing parts 332.

The long screw holes 334 are configured as pipes passing through a middle portion of the fixing parts 332, and are provided at locations corresponding to the screw holes 313″ provided in the middle portion of the first middle surface 313 of the inner member 310, so as to be coupled to screws inserted through the inner member 310.

The fixing plates 336 are provided in a horizontal direction on the top and bottom of the fixing parts 332.

Each fixing plate 336 may include projections 336′ protruding in a direction coupled to the inner member 310. Since the projections 336′ are seated in the top and bottom of the hollow part 313′ of the first middle surface 313 of the inner member 310, a user may easily fix the second member 320b coupled to the pillar 41, to the inner member 310 using screws.

Furniture using the above-described bracket will now be described. The following description focuses on the bracket illustrated in FIG. 13.

Ready-to-assemble furniture according to the present invention is applicable to a case in which two or more pillar members are used and, for convenience of explanation, the following description focuses on a case in which four pillar members are used.

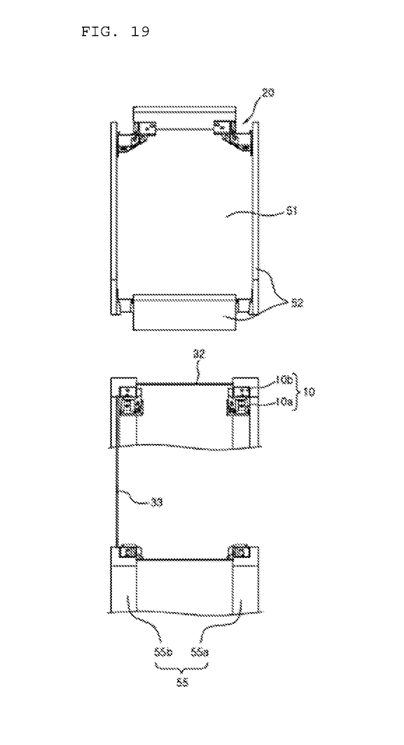

As illustrated in FIGS. 19 and 20, the ready-to-assemble furniture according to the present invention includes a pair of front pillar members 55a spaced apart from each other by a certain distance, rear pillar members 55b spaced apart from the front pillar members 55a by a certain distance and spaced apart from each other by the same distance as the front pillar members 55a, side panels 32 provided and fixed between the front and rear pillar members 55a and 55b, a rear panel 33 provided and fixed between the rear pillar members 55b, a plurality of upper panels 51 inserted and fixed into an internal space provided by the front and rear pillar members 55a and 55b, a plurality of inner brackets 10 separately mounted on the front and rear pillar members 55a and 55b, and a plurality of outer brackets 20 mounted on bottom surfaces of the upper panels 51, mounted on the vertical support members spaced apart from each other at a certain angle to insert the pillar members 55 therebetween, and configured to fit the inner brackets 10 thereinto.

Preferably, the side and rear panels 32 and 33 are slidably coupled to guide grooves 31′ provided in the pillar members 55. As such, since the side and rear panels 32 and 33 may have a smaller thickness than the pillar members 55, wood may be saved, a product weight may be reduced, and a process for fixing the side and rear panels 32 and 33 for assembly may be omitted.

Preferably, a plurality of inner brackets 10 are spaced apart from each other by a certain distance and mounted along a vertical direction of the pillar members 55, and the side and rear panels 32 and 33 are divided by a height corresponding to the distance between the inner brackets 10. In addition, preferably, to fix the side and rear panels 32 and 33, grooves configured to insert the side and rear panels 32 and 33 thereinto are provided in the vertical support members 52 mounted on the top and bottom upper panels 51.

For reference, herein, the upper panels 51 refer to not only upper panels but also plate materials mounted in a horizontal direction.

As illustrated in FIG. 21, an assembly method for assembling the above-described ready-to-assemble furniture, according to the present invention, includes separately mounting the inner brackets 10 on the four pillar members 55 corresponding to corners of the furniture, mounting the vertical support members 52 on bottom surfaces of the upper panels 51 and mounting the outer brackets 20 between the vertical support members 52, providing the rear pillar members 55b to be spaced apart from each other by a certain distance and to locate the inner brackets 10 at inner sides thereof and providing the front pillar members 55a to be spaced apart from the rear pillar members 55b by a certain distance and to locate the inner brackets 10 at inner sides thereof, and inserting the upper panels 51 into an internal space provided by the pillar members 55 and then coupling the outer brackets 20 of the upper panels 51 to the inner brackets 10 of the pillar members 55 to fix the upper panels 51, slidably coupling the rear panel 33 between the rear pillar members 55b, and slidably coupling the side panels 32 between the rear and front pillar members 55b and 55a.

In this case, the assembly method may further include fixing the upper panels 51 by assembling the inner and outer brackets 10 and 20 after the upper panels 51 are inserted, repeating the coupling of the rear and side panels 33 and 32, coupling a cover including the upper panels 51 to the top of the pillar members 55 when a desired number of the upper panels 51 are completely coupled, thereby completing furniture assembly.

In this case, preferably, grooves configured to insert the side and rear panels 32 and 33 thereinto are provided in the vertical support members 52 mounted on the top and bottom upper panels 51, e.g., the cover, thereby fixing ends of the side and rear panels 32 and 33.

Although an inner member and an outer member are separately produced and coupled to a pillar member and vertical support members in the above description, the pillar member and the inner member may be integrally produced or the vertical support members and the outer member may be integrally produced. For example, the pillar member and the inner member may be integrally produced and the vertical support members and the outer member may be integrally produced using a plastic injection process, and then the two may be coupled to each other.

While the present invention has been particularly shown and described with reference to embodiments thereof, it will be understood by one of ordinary skill in the art that various changes in form and details may be made therein without departing from the spirit and scope of the present invention as defined by the following claims.

### EXPLANATION OF REFERENCE NUMERALS

10, 60, 210, 310 . . . Inner member
20, 70, 220, 320 . . . Outer member
210a, 310a . . . First member
201b, 310b . . . Second member
51 . . . Upper panel
52 . . . Vertical support member
55 . . . Rectangular pillar member
55′ . . . L-shaped pillar member

1. A furniture assembly bracket for connecting a pair of vertical support members mounted on a bottom surface of an upper panel of furniture in directions perpendicular to each other, to a pillar member, the furniture assembly bracket comprising:
an inner member mounted outside the pillar member; and
an outer member mounted between the vertical support members spaced apart from each other at a certain angle to insert the pillar member therebetween, and configured to fit the inner member thereinto.

2. The furniture assembly bracket according to claim 1, wherein the inner member comprises:
a pair of fixing plates provided at a certain angle to closely contact two adjacent surfaces of the pillar member and having one or more screw holes; and
a middle plate having a middle portion contacting the pillar member, and configured to interconnect the fixing plates, and
wherein the outer member comprises:
a pair of fixing plates having one or more through holes so as to be screw-coupled to the vertical support members;
a pair of connection plates connected to the fixing plates in parallel with the vertical support members; and
a middle plate configured to interconnect the connection plates.

3. The furniture assembly bracket according to claim 2, wherein the outer member further comprises a base plate having through holes so as to be screw-coupled to the upper panel, and bent from the bottom of the middle plate or the connection plates.

4. The furniture assembly bracket according to claim 2, wherein cuts of a vertical direction are provided in the fixing plates of the inner member, and
wherein coupling plates to be fitted into the cuts of the fixing plates are provided on the connection plates of the outer member.

5. The furniture assembly bracket according to claim 2, wherein the outer member further comprises a plurality of positioning projections protruding from ends of the fixing plates and inserted into the vertical support members.

6. The furniture assembly bracket according to claim 2, further comprising one or more fitting plates provided at parts where the fixing plates and the connection plates of the outer member are connected to each other, so as to insert the fixing plates of the inner member thereinto,
wherein the fitting plates comprise:
extending parts extending from the fixing plates; and
fitting parts bent from ends of the extending parts to insert the fixing plates of the inner member thereinto.

7. The furniture assembly bracket according to claim 6, wherein side ridges other than top ridges of the fixing plates of the inner member have a small thickness so as to be inserted into the fitting plates, and
wherein the fixing plates have a descending width in a downward direction.

8. The furniture assembly bracket according to claim 1, wherein the inner and outer members are produced using a forging process,
wherein the inner member comprises:
a pair of fixing parts provided at a certain angle to closely contact two adjacent surfaces of the pillar member and having one or more screw holes in outer hollow parts thereof;
a middle part having a middle portion contacting a corner of the pillar member, configured to interconnect the fixing parts, and having at least one through hole; and
a ridge provided on top surfaces of the fixing parts and the middle part and having a head-hiding screw hole in a corner thereof, and
wherein the outer member comprises:
a pair of fixing parts having one or more through holes so as to be screw-coupled to the vertical support members;
connection parts connected to the fixing parts in parallel with the vertical support members;
a middle part having a screw hole corresponding to the head-hiding screw hole in a top surface thereof, having a through hole corresponding to the through hole of the inner member and configured as a slot hole, and configured to interconnect the connection parts;
a base plate having through holes configured as slot holes so as to be screw-coupled to the upper panel, and connected to the bottom of the middle part or the connection parts; and
fitting parts extending from the fixing parts and then bent so as to insert the fixing parts of the inner member thereinto.

9. The furniture assembly bracket according to claim 1, wherein the inner and outer members are produced using a forging process,
wherein the inner member comprises:
a pair of fixing parts closely contacting inner surfaces of an L-shaped pillar member and having one or more screw holes;
a middle surface part having a flat surface shape, located to face a corner of the fixing parts, and having a through hole at the center thereof;
connection parts configured to interconnect the fixing parts and the middle surface part and having rectangular through holes; and
a cover part provided on the top of the fixing parts, the connection parts, and the middle surface part and having a head-hiding screw hole provided in a corner thereof, which protrudes from the middle surface part, and
wherein the outer member comprises:
a pair of fixing parts having one or more through holes so as to be screw-coupled to the vertical support members;
connection parts connected to the fixing parts in parallel with the vertical support members;
a middle part having a screw hole corresponding to the head-hiding screw hole in a top surface thereof, having a through hole corresponding to the through hole of the inner member and configured as a slot hole, and configured to interconnect the connection parts;
a base plate having through holes configured as slot holes so as to be screw-coupled to the upper panel, and connected to the bottom of the middle part or the connection parts; and
fitting parts extending from the fixing parts and then bent so as to insert the fixing parts of the inner member thereinto.

10. The furniture assembly bracket according to claim 1, wherein the inner member is produced separately as a first member coupled to the outer member, and a second member mounted on the pillar member and coupled to inside of the first member.

11. The furniture assembly bracket according to claim 10, wherein the first member comprises:
a pair connection surfaces comprising hollow parts having one or more screw holes, and provided at an angle of 90°;
a first middle surface having a hollow part in a rear surface thereof, having a head-hiding screw hole at the center thereof, and configured to interconnect the connection surfaces; and
a ridge protruding forward from the bottom of the connection surfaces and the first middle surface and having a head-hiding screw hole corresponding to a screw hole provided at the center of the outer bracket, in a corner thereof, and
wherein the second member comprises:
a pair of fixing parts having a flat surface shape, having one or more screw holes, and connected to each other at an angle of 90°;
connection parts having a flat surface shape, connected to ends of the fixing parts at an angle of 90°, having rectangular through holes, and closely contacting the connection surfaces of the first member; and
a second middle surface located to face a corner of the fixing parts, having a through hole corresponding to the head-hiding screw hole of the first member, and inserted into the hollow part provided in the rear surface of the first middle surface.

12. The furniture assembly bracket according to claim 11, wherein the outer bracket comprises:
a pair of fixing parts having one or more through holes so as to be screw-coupled to the horizontal support members,
connection parts connected to the fixing parts in parallel with the horizontal support members,
a middle part having a screw hole corresponding to the head-hiding screw hole of the ridge, in a top surface thereof, having a head-hiding screw hole corresponding to the head-hiding screw hole of the first middle surface, and configured to interconnect the connection parts; and
a base plate having through holes configured as slot holes so as to be screw-coupled to the upper panel, and connected to the top of the middle part or the connection parts.

13. The furniture assembly bracket according to claim 12, wherein the inner bracket comprises protruding parts provided in a vertical direction and protruding from outer edges of the connection surfaces, and
wherein the outer bracket comprises fitting parts extending from the fixing parts and configured to insert the protruding parts thereinto.

14. Ready-to-assemble furniture comprising:
two or more pillar members;
a plurality of inner members separately mounted on the pillar members; and
a plurality of outer members configured to fit the inner brackets thereinto.

15. Ready-to-assemble furniture comprising:
a pair of front pillar members spaced apart from each other by a certain distance;
rear pillar members spaced apart from the front pillar members by a certain distance and spaced apart from each other by the same distance as the front pillar members;
side panels provided and fixed between the front and rear pillar members;
a rear panel provided and fixed between the rear pillar members;
a plurality of upper panels inserted and fixed into an internal space provided by the front and rear pillar members;
a plurality of inner brackets separately mounted on the front and rear pillar members; and
a plurality of outer brackets mounted on bottom surfaces of the upper panels, mounted on the horizontal support members spaced apart from each other at a certain angle to insert the pillar members therebetween, and configured to fit the inner brackets thereinto.

16. An assembly method of ready-to-assemble furniture, the assembly method comprising:
separately mounting inner brackets on two or more pillar members;
mounting horizontal support members on bottom surfaces of upper panels and mounting outer brackets between the horizontal support members;
providing a pair of rear pillar members to be spaced apart from each other by a certain distance and to locate the inner brackets at inner sides thereof and providing front pillar members to be spaced apart from the rear pillar members by a certain distance and to locate the inner brackets at inner sides thereof, and inserting the upper panels into an internal space provided by the pillar members and then coupling the outer brackets of the upper panels to the inner brackets of the pillar members to fix the upper panels;
slidably coupling the rear panel between the rear pillar members; and
slidably coupling the side panels between the rear and front pillar members.
